(19) United States
(12) Patent Application Publication
(10) Pub. No.: US 2013/0169570 A1
(43) Pub. Date: Jul. 4, 2013

(54) ELECTRONIC EQUIPMENT, STORAGE MEDIUM AND DELETION CONTROLLING METHOD

(71) Applicant: Kyocera Corporation, Kyoto-shi (JP)

(72) Inventors: Toshihiro KAMII, Osaka-shi (JP); Emiko KURIYAMA, Ikoma-gun (JP)

(73) Assignee: KYOCERA CORPORATION, Kyoto-shi (JP)

(21) Appl. No.: 13/720,296

(22) Filed: Dec. 19, 2012

(30) Foreign Application Priority Data
Dec. 19, 2011 (JP) 2011-276804

(51) Int. Cl. G06F 3/041

(52) U.S. Cl. CPC G06F 3/041
USPC 345/173

(57) ABSTRACT

A mobile phone being an example of electronic equipment includes a processor which determines whether or not a touch operation by a user is slid to draw a predetermined locus such as a zigzag based on touch coordinates data which is input from a touch control circuit and corresponds to the touch operation. If it is determined that the touch operation by the user draws the predetermined locus, a displayed object which is a deletion target is determined based on an operated range decided by the locus, and then, the displayed object is deleted.

### CROSS REFERENCE OF RELATED APPLICATION

The disclosure of Japanese Patent Application No. 2011-276804 filed on Dec. 19, 2011 is incorporated herein by reference.

### BACKGROUND OF THE INVENTION

1. Field of the Invention

The present invention relates to electronic equipment, a storage medium and a deletion controlling method, and more specifically, electronic equipment provided with a pointing device such as a touch panel, and a storage medium and a deletion controlling method.

2. Description of the Related Art

An example of a related art is disclosed in Japanese Patent Application Laying-Open No. 2003-248546 [G06F 3/03, G06F 3/00, G06F 3/033] laid-open on Sep. 5, 2003 (document 1). In a displaying apparatus with touch panel disclosed in the document, if an operator wishes to delete a character string, the operator designates an area to be deleted after “area setting” button is selected. Then, if the operator selects “tightening leading” button, the deletion area is deleted and a displaying is made in a manner that a character string following the deletion area is shifted to fill the deletion area having been deleted.

In the above-described displaying apparatus with touch panel disclosed in the document, if the character string is to be deleted, the operator must select a deletion mode, select “area setting” button, designates the deletion area, and select “tightening leading” button. The operation is troublesome.

### SUMMARY OF THE INVENTION

Therefore, it is a primary object of the present invention to provide novel electronic equipment, a storage medium and a deletion controlling method.

Another object of the present invention is to provide electronic equipment, a storage medium and a deletion controlling method, capable of easily deleting a displayed object with an intuitive operation.

A first aspect according to an embodiment is electronic equipment with a display portion which displays an object including at least a character, comprising: an operation detecting portion which detects a touch operation to a touch panel provided on a surface of the display portion; a determining portion which determines whether a touch operation detected by the operation detecting portion is an operation to draw a predetermined locus; and a deleting portion which deletes, when it is determined by the determining portion that the touch operation is an operation to draw the predetermined locus, a part or all of the object being displayed on the display portion and having a predetermined relationship with respect to points included in the locus of the touch operation.

A second aspect according to an embodiment is a non-transitory storage medium storing a deleting program for electronic equipment with a display portion which displays an object including at least a character, wherein the deleting program causes a processor of the electronic equipment to: detect a touch operation to a touch panel provided on a surface of the display portion; determine whether a touch operation detected is an operation to draw a predetermined locus; and delete, when it is determined that the touch operation is an operation to draw the predetermined locus, a part or all of the object being displayed on the display portion and having a predetermined relationship with respect to points included in the locus of the touch operation.

A third aspect according to an embodiment is a deletion controlling method of electronic equipment with a display portion which displays an object including at least a character, a processor of the electronic equipment performing steps of: detecting a touch operation to a touch panel provided on a surface of the display portion; determining whether a touch operation detected is an operation to draw a predetermined locus; and deleting, when it is determined that the touch operation is an operation to draw the predetermined locus, a part or all the object being displayed on the display portion and having a predetermined relationship with respect to points included in the locus of the touch operation.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an appearance view showing a mobile phone of an embodiment according to the present invention.

FIG. 2 is a view showing electrical structure of the mobile phone shown in FIG. 1.

FIG. 3(A) is a view showing an example of an email creating screen displayed on a display shown in FIG. 1, and FIG. 3(B) is a view showing a text inputting portion formed in the creating screen of FIG. 3(A).

FIG. 4 are views showing a method for deleting a character(s) displayed in the text inputting portion shown in FIG. 3(B), wherein FIG. 4(A) is a view showing a first example of a deleting operation, FIG. 4(B) is a view showing a deletion target determined by the deleting operation and a button image for stopping deletion, and FIG. 4(C) is a view showing the text inputting portion after deletion.

FIG. 5(A) is a view showing an example of a standby screen displayed on the display shown in FIG. 1, and FIG. 5(B) is a view showing a method for deleting an icon(s) displayed in an icon displaying area on the standby screen.

FIG. 6 are views showing another example of the method for deleting a character(s) or an image(s) displayed on the display shown in FIG. 1, wherein FIG. 6(A) is a view another example of a method for deleting a character(s) displayed in the text inputting portion shown in FIG. 3(B), and FIG. 6(B) is a view showing another example of a method for deleting an icon(s) displayed in the icon displaying area shown in FIG. 5(B).

FIG. 7(A) is a view showing an example of a method for determining whether or not it is a touch operation for deleting a character(s) or an image(s), and FIG. 7(B) is a view showing another example of the method for determining whether or not it is a touch operation for deleting a character(s) or an image(s).

FIG. 8(A) is a view showing a second example of the deleting operation of a character(s) or an image(s), FIG. 8(B) is a view showing a third example of the deleting operation of a character(s) or an image(s), FIG. 8(C) is a view showing a fourth example of the deleting operation of a character(s) or an image(s), and FIG. 8(D) is a view showing a fifth example of the deleting operation of a character(s) or an image(s).

FIG. 9(A) is a view showing a first example of an operated range determined based on a locus of a deleting operation for a character(s) or an image(s), FIG. 9(B) is a view showing a second example of an operated range determined based on a locus of a deleting operation for a character(s) or an image(s), FIG. 9(C) is a view showing a third example of an operated range determined based on a locus of a deleting operation for a character(s) or an image(s), FIG. 9(D) is a view showing a fourth example of an operated range determined based on a locus of a deleting operation for a character(s) or an image(s), and FIG. 9(E) is a view showing a fifth example of an operated range determined based on a locus of a deleting operation for a character(s) or an image(s).

FIG. 10(A) is a view showing a first example of a method for deciding a deletion target in accordance with the operated range determined as shown in FIGS. 9(A)-9(E), FIG. 10(B) is a view showing a second example of a method for deciding a deletion target in accordance with the operated range determined as shown in FIGS. 9(A)-9(E), and FIG. 10(C) is a view showing a third example of a method for deciding a deletion target in accordance with the operated range determined as shown in FIGS. 9(A)-9(E).

FIG. 11 is a view showing an example of a memory map of a RAM shown in FIG. 2.

FIG. 12 is a flowchart showing a part of a whole process by the processor shown in FIG. 2.

FIG. 13 is a flowchart showing another part of the whole process by the processor shown in FIG. 2, following FIG. 12.

FIG. 14 is a flow chart showing an example of touch operation determining processing by the processor shown in FIG. 2.

FIG. 15(A) is a view showing a sixth embodiment of a deleting operation of a character(s) or an image(s), FIG. 15(B) is a view showing a seventh example of the deleting operation of a character(s) or an image(s), and FIG. 15(C) is a view showing a eighth example of the deleting operation of a character(s) or an image(s).

FIG. 16 are views showing operated ranges each determined based on a locus of a deleting operation shown in FIGS. 15(A)-15(C), wherein FIG. 16(A) is a view showing an example of the operated range determined based on a locus of a deleting operation as shown in FIG. 15(A) or FIG. 15(B), FIG. 16(B) is a view showing an example of the operated range determined based on a locus of a deleting operation as shown in FIG. 15(C), and FIG. 16(C) is a view showing another example of the operated range determined based on a locus of a deleting operation as shown in FIG. 15(A) or FIG. 15(B).

FIG. 17 is a flowchart showing a part of a whole process by the processor in accordance with the further embodiments.

FIG. 18 is a flowchart showing another part of the whole process by the processor in accordance with the further embodiments, following FIG. 17.

FIG. 19(A) is a view showing a ninth embodiment of the deleting operation of a character(s) or an image(s), FIG. 19(B) is a view showing a tenth example of the deleting operation of a character(s) or an image(s), and FIG. 19(C) is a view showing a eleventh example of the deleting operation of a character(s) or an image(s).

FIG. 20(A) is a view showing a twelfth embodiment of the deleting operation of a character(s) or an image(s), and FIG. 20(B) is a view showing a thirteenth example of the deleting operation of a character(s) or an image(s).

FIG. 21 is a flowchart showing a part of a whole process by the processor in accordance with the other embodiments.

### DETAILED DESCRIPTION OF THE PREFERRED EMBODIMENTS

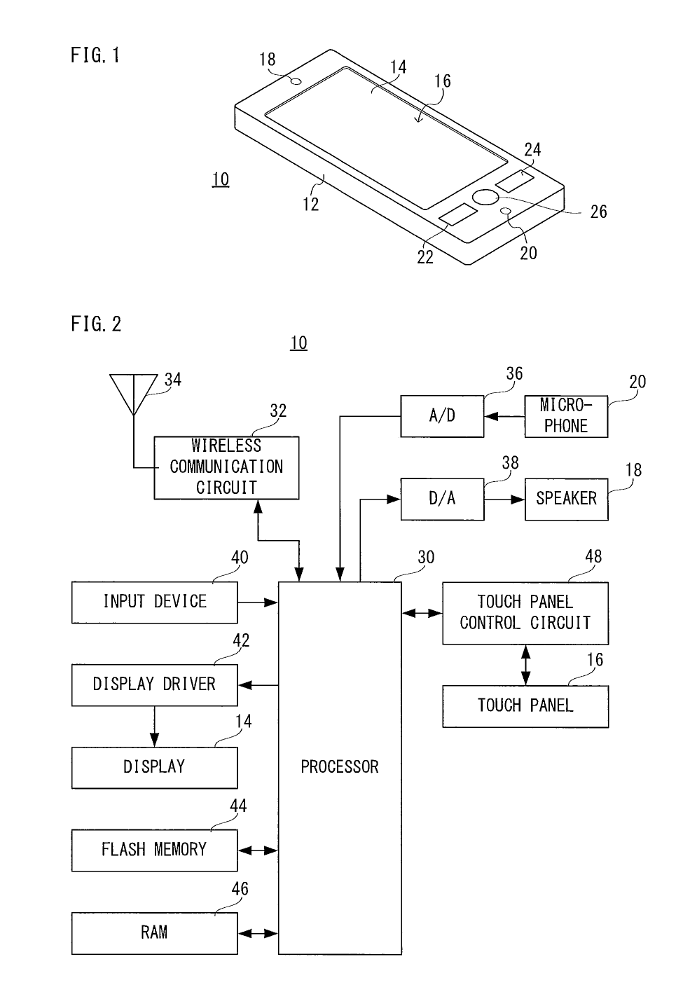

With referring to FIG. 1, a mobile phone 10 of an embodiment according to the present invention is a so-called smartphone, and includes a longitudinal flat rectangular housing 12. A display 14 constituted by a liquid crystal, organic EL or the like, which functions as a display portion, is provided on a main surface (front surface) of the housing 12. A touch panel 16 is provided on the display 14. A speaker 18 is housed in the housing 12 at one end of a longitudinal direction on a side of the front surface, and a microphone 20 is housed at the other end in the longitudinal direction on the side of the front surface. As a hardware key constituting an inputting portion together with the touch panel 16, a call key 22, an end key 24 and a menu key 26 are provided.

For example, the user can input a telephone number by making a touch operation on the touch panel 16 with respect to a dial key (not shown) displayed on the display 14, and start a telephone conversation by operating the call key 22. If and when the end key 24 is operated, the telephone conversation can be ended. In addition, by long-depressing the end key 24, it is possible to turn-on/-off a power of the mobile phone 10.

If the menu key 26 is operated, a menu screen is displayed on the display 14, and in such a state, by making a touch operation on the touch panel 16 with respect to a software key, a menu icon (both, not shown) or the like being displayed on the display 14, it is possible to select a menu, and to decide such a selection.

In addition, it is pointed out in advance that in this embodiment shown, a description is made on a mobile phone such as a smartphone which is an example of electronic equipment, but the present invention is applicable to various kinds of electronic equipment provided with a pointing device such as a touch panel. An arbitrary mobile terminal such as a feature phone, a tablet terminal, a PDA, etc. and further a note PC, a desktop PC or the like come within examples of other electronic equipment. In a case of the note PC or the desktop PC, instead of the touch panel, a touch pad, a computer mouse or the like may be used. That is, it is not necessary to limit a pointing device to the touch panel.

With referring to FIG. 2, the mobile phone 10 of the embodiment shown in FIG. 1 includes a processor 30. The processor 30 is connected with a wireless communication circuit 32, an A/D converter 36, a D/A converter 38, an input device 40, a display driver 42, a flash memory 44, a RAM 46, a touch panel control circuit 48, etc.

The processor 30 is called as a computer or a CPU and in charge of a whole control of the mobile phone 10. All or a part of a program set in advance in the flash memory 44 is, in use, developed or loaded into the RAM 46, and the processor 30 performs various kinds of processing in accordance with the program developed in the RAM 46. In addition, the RAM 46 is further used as a working area or buffer area for the processor 30.

The input device 40 includes the hardware keys (22, 24, 26) shown in FIG. 1, and functions as an operating portion or an inputting portion together with the touch panel 16 and the touch panel control circuit 48. Information (key data) of the hardware key operated by the user is input to the processor 30. Hereinafter, an operation with the hardware key is called as “key operation”.

The wireless communication circuit 32 is a circuit for transmitting and receiving a radio wave for a telephone conversation, a mail, etc. via an antenna 34. In this embodiment, the wireless communication circuit 32 is a circuit for performing a wireless communication with a CDMA system. For example, if the user designates a telephone dispatch (telephone call) using the input device 40, the wireless communication circuit 32 performs a telephone call processing under instructions from the processor 30 and outputs a telephone call signal via the antenna 34. The telephone call signal is transmitted to a telephone at the other end of the line through a base station and a communication network. Then, an incoming processing is performed in the telephone at the other end of the line, a communication-capable state is established and the processor 30 performs the telephonic communication processing.

Specifically describing a normal telephonic communication processing, a modulated sound signal sent from a telephone at the other end of the line is received by the antenna 34. The modulated sound signal received is subjected to demodulation processing and decode processing by the wireless communication circuit 32. A received sound signal obtained through such processing is converted into a sound signal by the D/A converter 38 to be output from the speaker 18. On the other hand, a sending sound signal taken-in through the microphone 20 is converted into sound data by the A/D converter 36 to be applied to the processor 30. The sound data is subjected to an encode processing and a modulation processing by the wireless communication circuit 32 under instructions by the processor 30 to be output via the antenna 34. Therefore, the modulated sound signal is transmitted to the telephone at the other end of the line via the base station and the communication network.

When the telephone call signal from a telephone at the other end of the line is received by the antenna 34, the wireless communication circuit 32 notifies the processor 30 of the incoming call. In response thereto, the processor 30 displays on the display 14 sender information (telephone number and so on) described in the incoming call notification by controlling the display driver 42. In addition, the processor 30 outputs from the speaker 18 a ringtone (may be also called as a ringtone melody, a ringtone voice).

Then, if the user performs an answering operation by using the call key 22 (FIG. 1) included in the input device 40, the wireless communication circuit 32 performs processing for establishing a communication-capable state under instructions by the processor 30. Furthermore, when the communication-capable state is established, the processor 30 performs the above-described telephone communication processing.

If the telephone communication ending operation is performed by the end key 24 (FIG. 1) included in the input device 40 after a state is changed to the communication-capable state, the processor 30 transmits a telephone communication ending signal to the telephone at the other end of the line by controlling the wireless communication circuit 32. Then, after the transmission of the telephone communication ending signal, the processor 30 terminates the telephone conversation processing. Furthermore, in a case that the telephone ending signal from the telephone at the other end of the line is received before the telephone conversation ending operation at this end, the processor 30 also terminates the telephone conversation processing. In addition, in a case that the telephone conversation ending signal is received from the mobile communication network not from the telephone at the other end of the line, the processor 30 also terminates the telephone conversation processing.

In addition, the processor 30 adjusts, in response to an operation of a volume by the user, a sound volume of the sound output from the speaker 18 by controlling an amplification factor of the amplifier connected to the D/A converter 38.

The display driver 42 controls a displaying by the display 14 which is connected to the display driver 42 under instructions by the processor 30. In addition, the display driver 42 includes a video memory temporarily storing image data to be displayed. The display 14 is provided with a backlight which includes a light source of an LED or the like, for example, and the display driver 42 controls, according to the instructions of the processor 30, brightness, light-on/-off of the backlight.

The touch panel 16 shown in FIG. 1 is connected to a touch panel control circuit 48. The touch panel control circuit 48 inputs to the processor 30 a turning-on/-off of the touch panel 16, a touch start signal indicating a start of a touch by the user, a touch end signal indicating an end of a touch by the user, and coordinates data (touch coordinates data) indicating a touch position that the user touches. The processor 30 can determine which icon or key is touched by the user based on the coordinates data input by the touch panel control circuit 48.

In the embodiment, the touch panel 16 is of an electrostatic capacitance system that detects a change of an electrostatic capacitance between electrodes, which occurs when an object such as a finger is in close to a surface of the touch panel 16, and it is detected that one or more fingers is brought into contact with the touch panel 16, for example. The touch panel control circuit 48 functions as a detecting portion, and detects a touch operation within a touch-effective range of the touch panel 16, and outputs coordinates data indicative of a position of the touch operation to the processor 30.

Here, various kinds of touch operations that the touch panel 16 receives are described. An operation that the touch panel 16 is touched, and then, the touch panel (the finger(s)) is released while the position touched is hardly changed, for example is called as “tap”. An operation that the touch panel 16 is touched, and then, the finger is slid and released in a filliped manner is called as “flick”. For example, within a first predetermined time period (500 milliseconds) from a timing that the user touches the touch panel 16, if the finger is released after the finger is slid by a predetermined distance (50 dots) or more, such an operation is determined as “flick”. Hence, if exceeding the first predetermined time period, it is determined as mere “slide”. Furthermore, in a case that “tap” is performed twice continuously within a second predetermined time period (500 milliseconds-2.0 seconds), such an operation is determined as “double tap”.

Hereinafter, if it is not necessary to accurately distinguish the kinds of the operation that the touch panel 16 receives, a term “touch operation” is commonly used.

In addition, for a detection system of the touch panel 16, a surface-type electrostatic capacitance system may be adopted, or a resistance film system, an ultrasonic system, an infrared ray system, an electromagnetic induction system or the like may be adopted. Furthermore, a touch operation is not limited to an operation by a finger, may be performed by a touch pen.

In addition, the above-described wireless communication circuit 32, the A/D converter 34 and the D/A converter 36 may be included within the processor 30.

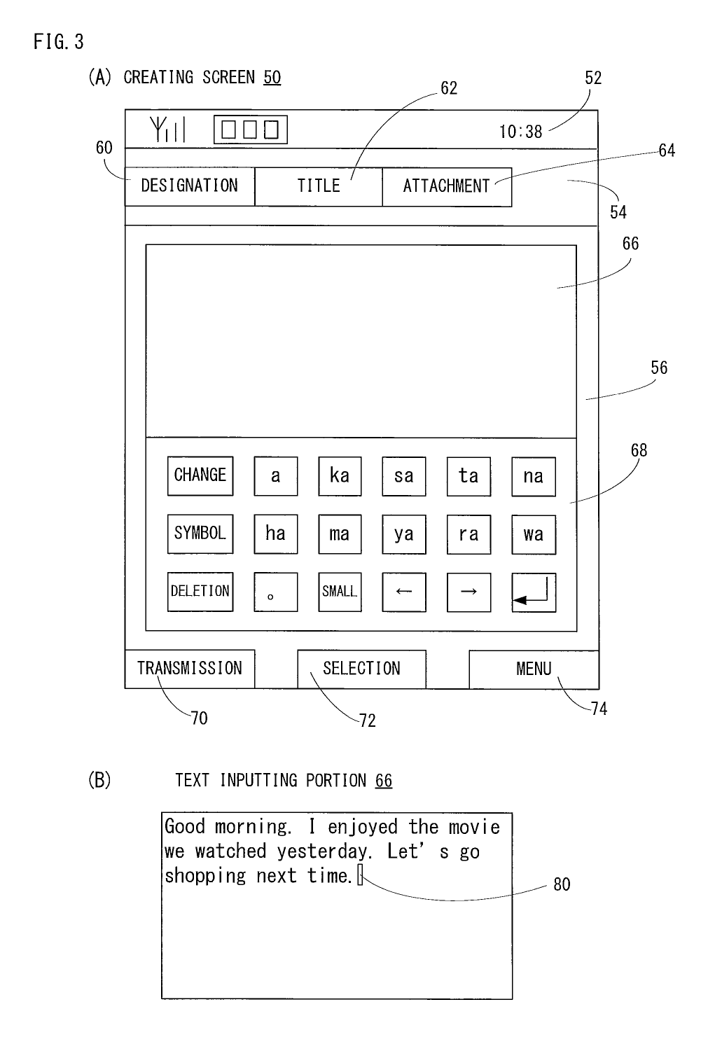

FIG. 3(A) shows an example of a screen for creating an email (a creating screen) 50. The creating screen 50 includes displaying areas 52, 54 and 56. The displaying area 52 displays with an image indicative of a strength of a radio wave, an image indicative of a residual quantity of a battery and a character string indicative of a current time. The displaying area 54 displays with button images 60, 62 and 64. The button image 60 is provided to input a designating address of an email. The button image 62 is provided to input a title of the email, and the button image 64 is provided to attach data to the email.

In the displaying area 56, a text input portion 66 is formed, and a character input key 68 is displayed below the text input portion 66, and button images 70, 72 and 74 are displayed below the character input key 68. In the text input portion 66, a character or the like designated by making a touch operation on the character input key 68 is displayed. The character input key 68 is used for inputting a character or the like that is displayed in the text input portion 66. An example of a case that a character is input to the text input portion 66 is shown in FIG. 3(B). Although omitted in FIG. 3(A), as shown in FIG. 3(B), a cursor 80 for indicating a position that a character is input or the like is displayed.

The button image 70 is provided to transmit an email. The button image 72 is provided to select a converted content or an input symbol from a plurality of candidates when a content being displayed with Japanese “hiragara” is to be converted into Japanese “kanji” or a symbol is to be input. The button image 74 is provided to display a menu screen in a case that various kinds of setting items for an email are to be selected.

Conventionally, in a case that a character is to be deleted during an editing of characters that creates a text of an email, for example, by operations by a user, a deletion mode is selected, a start position and an end position of a character string to be deleted (deletion target) are designated, and an implementation of deletion is designated. In response to such operations, the deletion target is deleted, and a following character or character string is closed forward such that a space that the deletion target was displayed is filled. Alternatively, by operating a key for deleting a character one by one, a character is deleted to return by one character from a position designated by the cursor 80.

In the former case, it is necessary to select a deletion mode, designate a start position and an end position to decide a deletion target, and designate an implementation of a deletion, and therefore, an operation is troublesome. In the latter case, since it is necessary to move the cursor to a position that a character of the deletion target is being displayed, it is troublesome to repeatedly tap the key for moving the cursor, and further, in a case that a character being displayed is small, it is relatively difficult to directly move the cursor to a position that the character of the deletion target is being displayed. Furthermore, in a case that an icon or thumbnail (a displayed image with reduction) is to be deleted, it is necessary to perform an operation different from an operation of the case that a character is deleted. For example, in a case that the icon or the thumbnail is to be deleted, by long-depressing the icon or thumbnail to be deleted (by continuously touching a few seconds or more, for example), the long-depressed of the icon or thumbnail is transited to a deletion-capable state, and further, in such a state, the deletion is designated by tapping a deletion mark or a deletion icon, and the deletion is implemented.

In the above-described conventional arts, in a case that a deleting operation is performed, it is necessary for the user to perform a plurality of times of operations for each deletion target of the character or the image.

Accordingly, in this embodiment shown, in order to easily delete a character or an image (icon, thumbnail) through an intuitive operation irrespective of the character or the image, a designation and a deletion of the deletion target is performed.

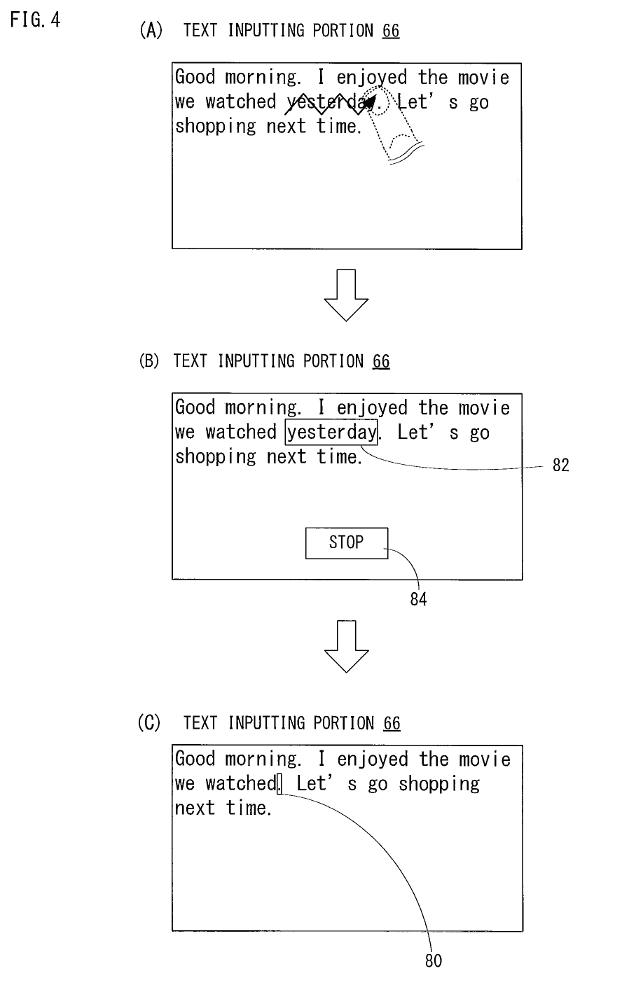

For example, as shown in FIG. 4(A), a user slides a finger on a character or a character string to be deleted so as to represent a predetermined locus. In an example shown in FIG. 4(A), the finger is slid to draw a zigzag. In addition, the locus of the slide may be displayed on the screen or may not be displayed on the screen. When the slide is ended, as shown in FIG. 4(B), a deletion target is decided based on a range decided by the slide (an operated range). When the deletion target is decided, the deletion target is surrounded by a rectangular frame 82; however, this is merely an example, and accordingly, a further displaying method may by adopted as far as the deletion target can be confirmed visually. As the further displaying method, a color of a character or a size of a character may be changed.

Furthermore, as shown in FIG. 4(B), when the deletion target is decided, a button image 84 is displayed in the text input portion 66. The button image 84 is provided to stop the deletion. When a third predetermined time period (3 seconds, for example) elapses from a timing that the deletion target is decided while the button image 84 is not turned-on (tapped), the deletion is performed.

Therefore, as shown in FIG. 4(C), when the deletion target is deleted, the character string following the deletion target is moved forward to fill the space. At this time, the cursor 80 is displayed at the start position of a place where the deletion target was displayed. In addition, as shown in FIG. 3(B), the cursor 80 may remain to be displayed at an end position of the character string.

In addition, in this embodiment shown, the button image 84 is displayed when the deletion target is decided, and if the button image 84 is tapped until the third predetermined time period elapses, the deletion is stopped; however, a stopping method (operation) of the deletion is not limited to such a method. For example, instead of the tapping of the button image 84, the hardware keys (22, 24 and 26) may be operated (turned-on). Furthermore, instead of the tapping of the button image 84, a predetermined character (“C” in alphabet, for example) or a predetermined symbol (a cross (x) mark, for example) may be drawn on the touch panel 16.

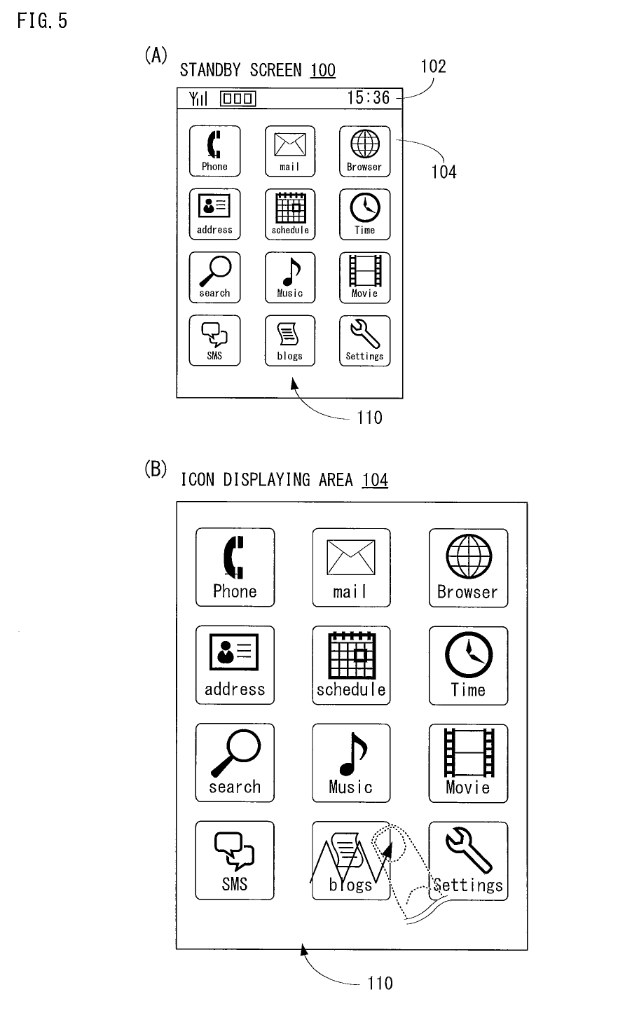

FIG. 5(A) shows an example of a standby screen 100. The standby screen 100 includes a displaying area 102 and a displaying area 104. The displaying area 102 is displayed with an image indicative of the strength of the radio wave, an image indicative of the residual quantity of a battery and a character string indicative of the current time. The displaying area 104 is displayed with a plurality of icons 110 for activating (performing) various kinds of applications.

As shown in FIG. 5(B), in a case that an icon 110 is to be deleted, a user also slides a finger to draw a zigzag on the icon 110 that the user wishes to delete. A deletion target is decided according to an operated range designated by a slide operation, the deletion target may be surrounded by a rectangular frame 82, or a displaying color or a displaying size of the deletion target may be changed. Furthermore, at this time, a button image for stopping the deletion is displayed at any position in the displaying area 104. Then, a third predetermined time period elapses without tapping the button image for deletion, the deletion target is deleted.

In addition, it is true for a case that a thumbnail is to be deleted. In a case that the icon 110 or the thumbnail is to be deleted, an icon or a thumbnail not being displayed in the displaying area 104 may be displayed in the displaying area 104 instead of the deleted icon 110 or thumbnail, the space after the deletion may be kept empty.

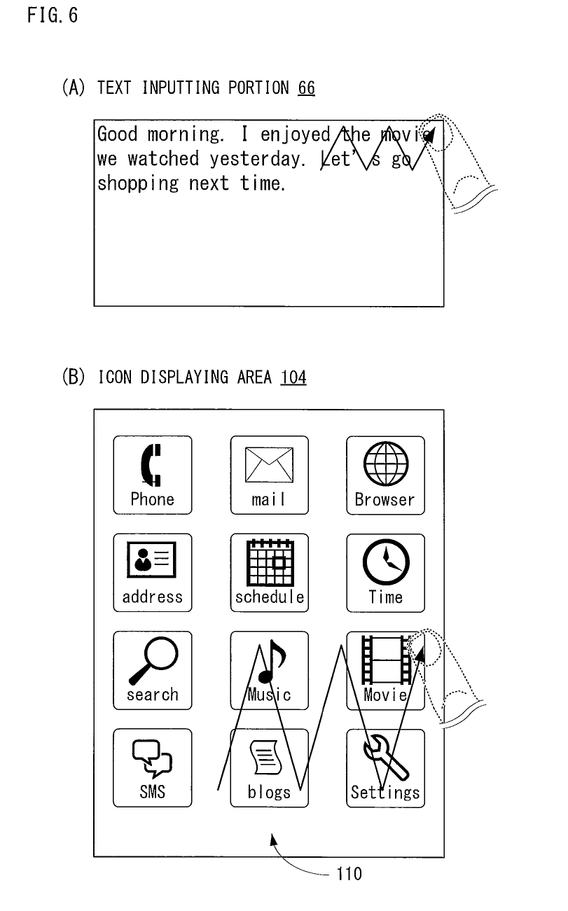

As shown in FIG. 6(A), if a user slides a finger on a character string over a plurality of lines to draw a zigzag, the character string over the plurality of lines can be deleted in accordance with an operated range decided by the slide. A character string to be deleted need not be consecutive one, and thus, a part of a character string over a plurality of lines can be also deleted. Similarly, if a user slides a finger in a plurality of rows and/or columns to draw a zigzag on icons 110, the plurality of icons 110 can be deleted at once according to an operated range decided by such a slide.

Thus, by sliding a finger to draw a zigzag, a character string within a line and an icon or thumbnail can be deleted, and further, a character string over a plurality of lines or a plurality of icons or thumbnails can be deleted at once by similarly sliding a finger to draw a zigzag.

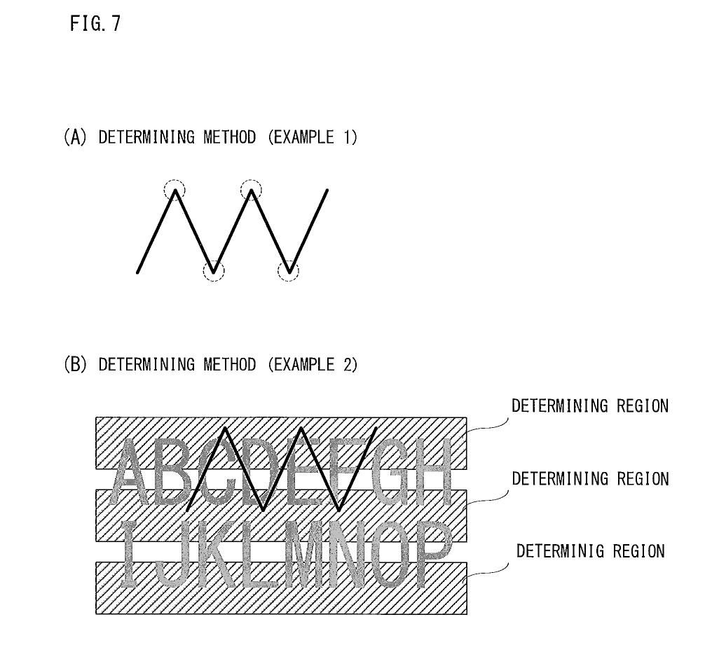

Next, a method for determining whether or not a finger is slid to draw a zigzag (i.e. a determining method) will be described. As shown in FIG. 7(A), if and when a predetermined number of (two, for example) mountains (convex portions) and valleys (concave portions) are detected in turn, it is determined that the finger is slid to draw a zigzag. That is, it is determined that an operation for deleting a displayed object (a deleting operation) is performed, but a stroke order of the zigzag is not restricted. Furthermore, the mountain and the valley of a zigzag can be detected in accordance with a change of touch coordinates detected when the finger is being slid.

A two-dimensional coordinate system is set for the touch panel 16, and a Y axis is set in parallel with a vertical direction (longitudinal direction) and an X axis is set in parallel with a horizontal direction (direction orthogonally intersecting to the vertical direction). In a state that the mobile phone 10 is set in the vertical direction, an upper direction is a plus direction of the Y axis and a right direction is a plus direction of the X axis. Furthermore, the origin is set at a point corresponding to a lower left corner (apex) of the display 14 in a state that the mobile phone 10 is held in the vertical direction.

In addition, the two dimensional coordinates system set on the touch panel 16 also corresponds to the display 14. Therefore, the touch coordinates detected in response to a touch operation to the touch panel 16 corresponds to the positional coordinates on the display 14.

In this embodiment, as in the creating screen 50 shown in FIG. 3(A) or the standby screen 100 shown in FIG. 5(A), in a case that a longitudinal screen is displayed, according to a change of a Y component of the touch coordinates, the mountain and the valley are determined. That is, the mountain is detected if the Y components of the touch coordinates aligned in a time series is changed from increase to decrease, the valley is detected when the Y component is changed from decrease to increase.

In addition, in a case that the mobile phone 10 is set in the horizontal direction, that is, in a case that a horizontally wide screen is displayed, the mountain and the valley can be detected according to a change of the X component of the touch coordinates.

As shown in FIG. 7(B), in a case that a determining region is set in correspondence to the displaying area set in the display 14, when a locus of the slide is alternatively detected in the determining regions arranged up and down, it is determined that the finger is slid to draw a zigzag. For example, the determining region is set to cover an upper portion and a lower portion of a character in continuous two lines, but, the determining region of the uppermost is set to cover only an upper portion of a character string in the first line, and the determining region of the lowermost is set to cover only an lower portion of a character string in the last line. Furthermore, the determining region is variably set in accordance with a size of a displayed character (font size).

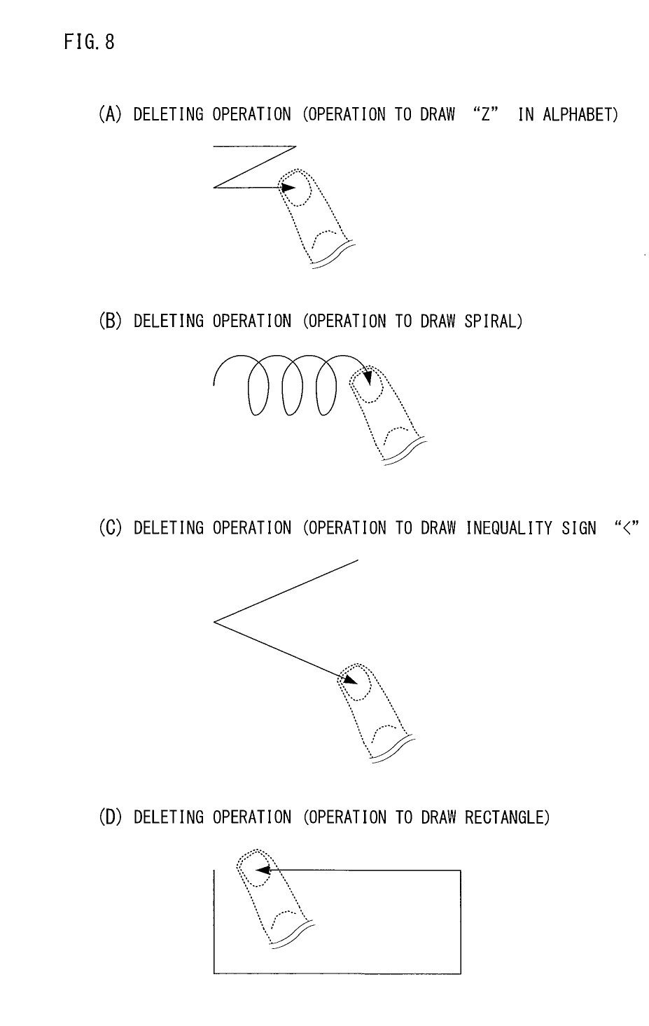

In this embodiment, in order to perform a deleting operation as in a case that a character string written on a piece of paper or the like is erased by using an eraser, by sliding a finger to draw a zigzag, a range to be deleted is to be decided and then, the deletion is implemented. However, in order to perform an intuitive operation, a finger may be slid (moved) to write or draw another symbol or figure. In FIG. 8(A)-FIG. 8(D), examples that another symbol or figure is drawn at one operation (one-stroke drawing) are shown.

FIG. 8(A) shows a finger is slid to draw “Z” in alphabet. FIG. 8(B) shows a finger is slid to draw a spiral. FIG. 8(C) shows a finger is slid to draw “<” of an inequality sign. A finger may be slid to draw “>” of an inequality sign. FIG. 8(D) shows a finger is slid to draw a predetermined figure (here, a rectangle or quadrilateral). In addition, as other examples, the predetermined figure may be a circle shape, a triangle shape, etc.

In a case that the finger is slid to draw “Z”, a spiral or “<”, for example, as similar to a case that the finger is slid to draw a zigzag, the finger is slid on a character(s) and an image(s) such as an icon or thumbnail to be deleted (hereinafter, these may be collectively called as “displayed object”). Furthermore, in a case that a predetermined figure is to be drawn, the finger is slid to surround a displayed object to be deleted. However, even in a case that a predetermined figure is to be drawn, the finger may be slid on a displayed object to be deleted.

In addition, determination on whether or not a locus of slide represents each symbol or figure is performed based on the feature of the symbol or figure as similar to a case of determination of the zigzag. Briefly described, it is determined that the finger is slid to draw “Z” in the case that in the touch coordinates detected according to a time series, a Y component hardly changes while an X component increases, the X component turns over for decrease from increase, the X component and the Y component decrease, the X component turns over for increase from decrease, and then the Y component hardly changes and the X component increases. However, it is determined that the finger is slid to draw “Z” based on a positional relationship of a start point, an end point and two reversed points.

Furthermore, in a case that in the touch coordinates detected according to a time series, a mountain and a valley are detected in turn, it is determined that the finger is slid to draw a spiral. In addition, in a case that a spiral is to be drawn in a direction indicated in FIG. 8(B), that is, a plus direction of an X axis, if the mountain is to be detected based on a change of the Y component from increase to decrease, the X component increases, and if the valley is to be detected based on a change of the Y component from decrease to increase, the X component decreases. However, it is possible to determine that the finger is slid to draw a spiral in a case that a determining region is set in the displaying area as shown in FIG. 8(B), and the locus of slide is alternately detected in the determining regions arranged up and down.

Furthermore, in a case that in the touch coordinates detected according to a time series, an X component is increasing and a Y component also decreases, the X component turns over for increase from decrease, and the X component is increasing while the Y component decreases, it is determined that the finger is slid to draw “<”. In addition, it is possible to determine that the finger is slid to draw “<” based on a positional relationship of a start point, an end point and a reversed point.

Furthermore, in a case that in the touch coordinates detected according to a time series, a vertical line drawn from the upper to the lower, a horizontal line drawn from left to right, a vertical line drawn from the lower to the upper and a horizontal line drawn from right to left are sequentially detected, it is determined that a rectangle or quadrilateral shape is drawn. In addition, it is possible to determine a quadrilateral shape based on a relationship of a start point, an end point and other three points at which a drawing direction is changed.

If and when a deleting operation described above for deleting a displayed object is detected, a displayed object of a deletion target is decided based on the deleting operation. For example, it is possible to decide a displayed object overlapping with a plurality of touch positions (touch coordinates) constituting a locus of slide at a time that the deleting operation is performed as a deletion target.

However, in a case that the finger is slid to draw a zigzag on a character string over a plurality of lines or a plurality of images (icon or thumbnail), there is a possibility that the locus of slide does not pass over a character or an image between the mountains, or between the valleys. This is true for a case that the finger is slid to draw “Z”, the spiral or “<”. Furthermore, in a case that the finger is slid to draw a predetermined figure such as a rectangle, the locus of slide does not pass on a character or figure inside the predetermined figure. That is, in such a case, a character or figure included in a range of a finger slide, but over which the locus of slide does not pass may not be selected as the deletion target.

Therefore, in this embodiment, if a deleting operation is detected, a range of a deleting operation (hereinafter, called as “an operated range”) based on the touch coordinates included in the locus of slide at a time that the deleting operation is performed is decided, and a displayed object overlapping with the operated range is decided as the deletion target.

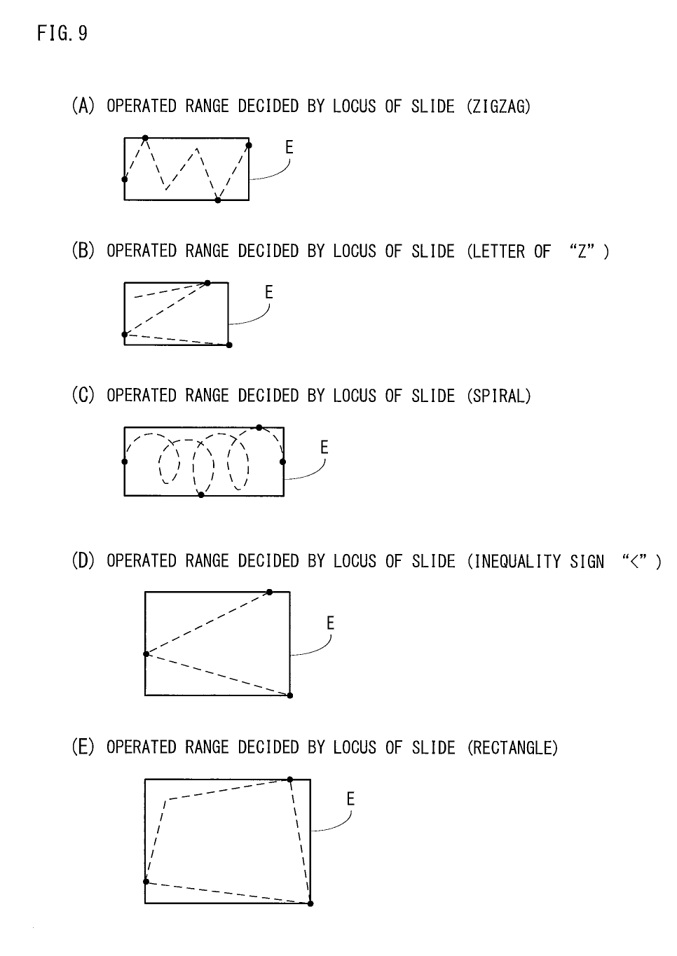

At first, a method for deciding an operated range E by a locus of slide for a deleting operation is described. Respectively shown in FIG. 9(A)-FIG. 9(E), a minimum value and a maximum value of an X component and a minimum value and a maximum value of a Y component in touch coordinates constituting a locus of slide of a case that a symbol or figure is drawn are extracted, and a quadrilateral shape formed by straight lines that are decided by these values and in parallel with an Y axis and an X axis is decided as the operated range E.

In addition, in FIG. 9(A)-FIG. 9(E), in order to clearly show a deciding method of the operated range E, a character, a symbol and a figure are illustrated with slight deformation, but it is considered that deformation in some degrees also occurs in the case that the user slides his or her finger or the like.

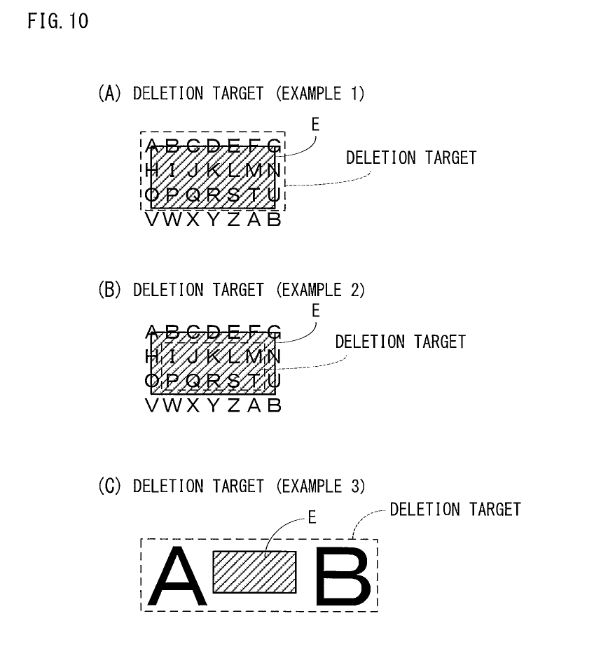

A deletion target is decided based on the operated range E thus decided. FIG. 10(A) shows an example of a method for deciding a deletion target. Specifically, if at least a part of a character overlaps the operated range E, the character is decided as the deletion target. In addition, in FIG. 10(A) (also in FIG. 10(B) and FIG. 10(C)), the operated range E is indicated by a rectangle with slant lines. In an example shown in FIG. 10(A), the operated range E is overlapped with parts of “A-G”, “H”, “N”, “O” and “U” and includes “I-M” and “P-T”. Thus, the deletion target is decided for a character string “A-U” surrounded by a rectangular shape illustrated by dotted lines.

Furthermore, in FIG. 10(B), another example of a method for deciding a deletion target is shown. Specifically, characters included in the operated range E as a whole are decided as a deletion target. In FIG. 10(B), “A-G”, “H”, “N”, “O” and “U” parts of which overlap the operated range E do not become a deletion target. Therefore, the deletion target is decided for a character string “I-M” and “P-T” surrounded by a rectangular shape illustrated by dotted lines.

In addition, in a case that the operated range E overlaps a character string or surrounds a character string, a deletion target is decided by a method of FIG. 10(A) or FIG. 10(B). Which method is to be adopted is set in advance.

FIG. 10(C) shows the other example of a method for deciding a deletion target. FIG. 10(C) shows a state that a deleting operation is performed between characters in a case that the characters are displayed with being enlarged. In such a case, the characters to which an operated range E is adjacent are decided as a deletion target.

It is noted that the above-described embodiments can be similarly applied to a case that an image(s) such as an icon or thumbnail is to be deleted.

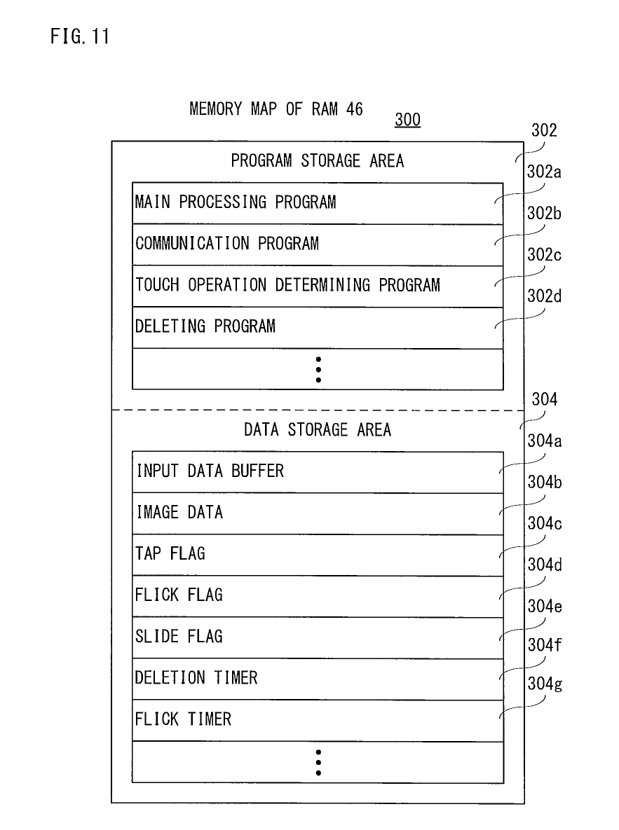

FIG. 11 shows an example of a memory map 300 of the RAM 46 shown in FIG. 2. The RAM 46 includes a program storage area 302 and a data storage area 304. The program storage area 302 is stored with a control program for the mobile phone 10, and the control program is constructed by a main process program 302a, a communication program 302b, a touch operation determining program 302c, a deleting program 302d, etc.

The main process program 302a is a program for processing a main routine for a whole control of the mobile phone 10. The communication program 302b is a program for performing telephone conversation processing with another telephone or for performing data communication processing with another telephone or computer. The touch operation determining program 302c is a program for determining whether a touch operation is “tap”, “flick” or “slide”. The deleting program 302d is a program for deleting a displayed object.

Although not shown, the program storage area 302 is further stored with a program for displaying various kinds of screens, a program for producing and outputting sound, and a program for performing other functions or various kinds of applications.

The data storage area 304 is provided with an input data buffer 304a, and stored with image data 304b. Furthermore, the data storage area 304 is provided with a tap flag 304c, a flick flag 304d and a slide flag 304e. The data storage area 304 is also provided with a deletion timer 304f and a flick timer 304g.

The input data buffer 304a is a region for temporarily storing a key data input from the input device 40 and a touch coordinates data input from the touch panel control circuit 48. The key data or the touch coordinates data stored in the input data buffer 304a are erased after the same are used for processing by the processor 30. The image data 304b is data for depicting (producing) displayed image data corresponding to various kinds of screens.

The tap flag 304c is a flag for determining whether or not the touch operation indicates a tap. The tap flag 304c is constituted by a 1-bit register, and if the flag is turned-on, a data value “1” is set in the register, and if the flag is turned-off, a data value “0” is set in the register. Then, if the touch operation shows a tap, the tap flag 304c is turned-on, and if the touch operation does not show a tap, the tap flag 304c is turned-off. This is true for the flick flag 304d and the slide flag 304e described later.

The flick flag 304d is a flag for determining whether or not the touch operation indicates a flick. The slide flag 304e is a flag for determining whether or not the touch operation indicates a slide.

The deletion timer 304f is a timer for counting a third predetermined time period from a timing that a deletion target is decided to a timing that the deletion is performed. The flick timer 304g is a timer for counting a first predetermined time period for determining whether or not the touch operation is a flick.

Although not shown, the data storage area 304 is further stored with other data necessary for performing the control program, and provided with other flags and other timers (counters).

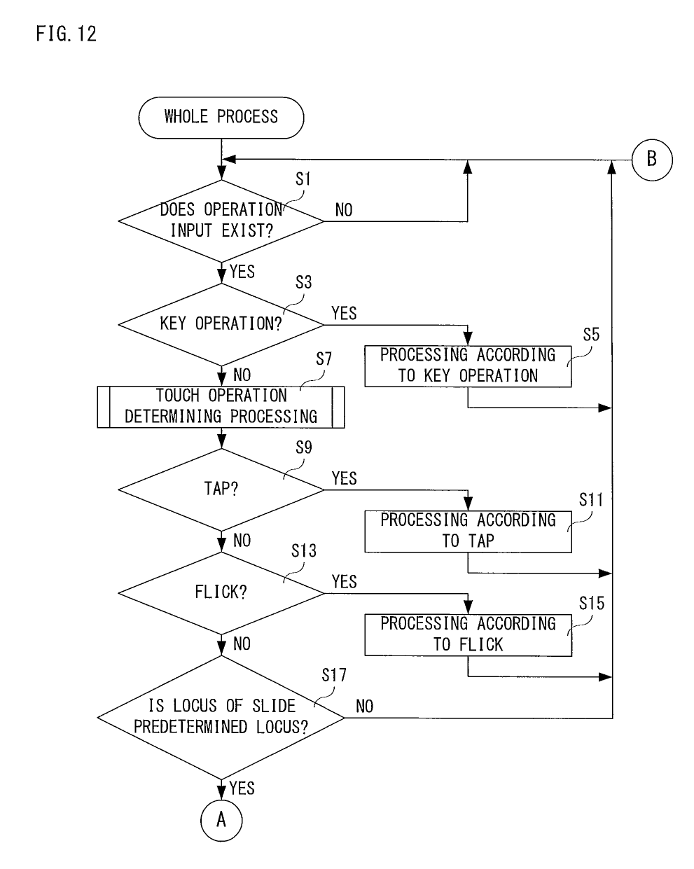

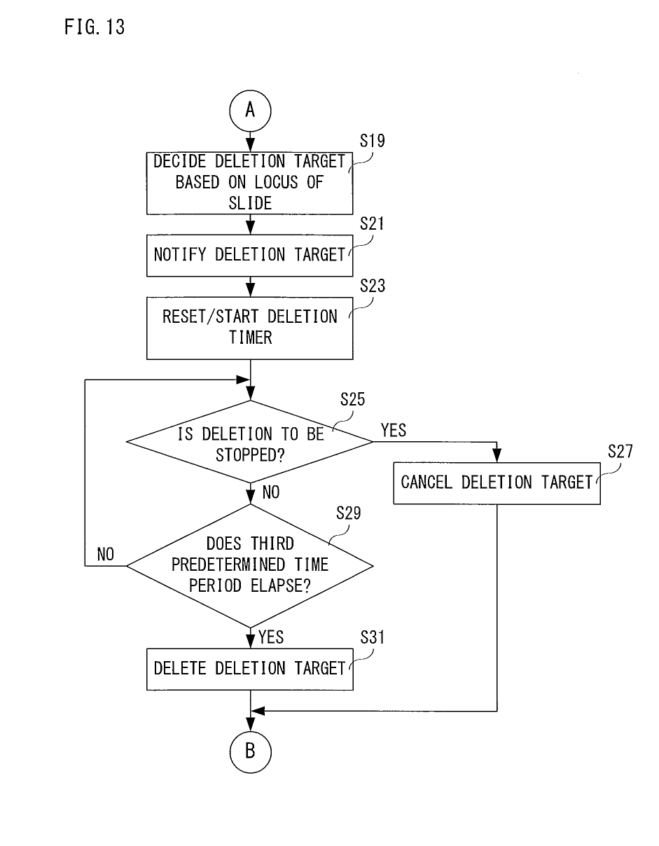

FIG. 12 and FIG. 13 are flowcharts showing a whole process of the processor 30 shown in FIG. 2. In addition, in this embodiment shown, for simplification, an operation that a screen is scrolled and an operation that an image such as an icon, thumbnail or the like is dragged are not performed.

As shown in FIG. 12, when the whole process is started, the processor 30 determines whether or not an operation input exists in a step S1. In this step, it is determined whether or not key data or touch coordinates data is stored in the input data buffer 304a. Although not shown, processing for detecting the key data or the touch coordinates data is performed through a task separated from the whole process, and detected key data or touch coordinates data is stored in the input data buffer 304a.

If “NO” is determined in the step S1, that is, if no operation input exists, the process returns to the step S1 with no action. If “YES” is determined in the step S1, that is, if the operation input exists, in a step S3, it is determined whether or not the operation input is a key operation.

If “YES” is determined in the step S3, that is, if the operation input is the key operation, processing according to the key operation is performed in a step S5, and then the process returns to the step S1. For example, if the call key 22 is operated, the calling processing is started through a further task, or a telephone conversation is started in response to an incoming call. If the end key 24 is operated, the conversation processing is terminated. If the menu key 26 is operated, a menu function is performed through a further task. These are only examples, and not to be limited thereto. That is, a function assigned to the hardware keys (22, 24, 26) or the like is performed.

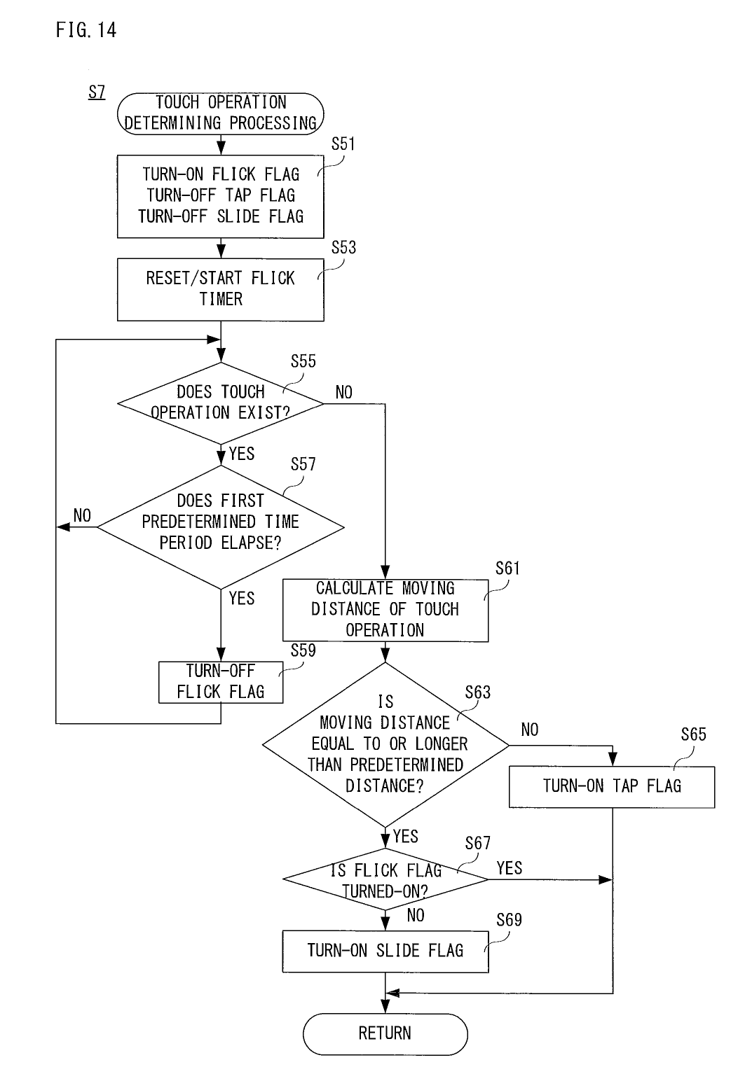

On the other hand, if “NO” is determined in the step S3, that is, if the operation input is not a key operation, it is determined that a touch operation is performed, and in a step S7, touch operation determining process (FIG. 14) described later is performed, and in a step S9, it is determined whether or not a touch operation is a tap. In the step S9, the processor 30 determines whether or not the tap flag 304c is turned-on. If “YES” is determined in the step S9, that is, if the touch operation is a tap, in a step S11, processing according to the tap is performed, and then the process returns to the step S1. For example, if an icon is tapped, an application assigned to the icon is activated (performed) through a further task. If a thumbnail is tapped, a still picture or a moving image according to the thumbnail is displayed on the display 14. Furthermore, it is possible to select a desired content in the menu screen. These are only examples, and not to be limited thereto. That is, processing according to an object image displayed at a tapped position is performed.

On the other hand, if “NO” is determined in the step S9, that is, if the touch operation is not a tap, in a step S13, it is determined whether or not a touch operation is a flick. That is, the processor 30 determines whether or not the flick flag 304d is turned-on. If “YES” is determined in the step S13, that is, if the touch operation is a flick, in a step S15, processing according to the flick is performed, and then the process returns to the step S1. For example, a screen is moved (scrolled) in a direction reverse to a flicked direction. This is only an example, and not to be limited thereto.

If “NO” is determined in the step S13, that is, if the touch operation is not a flick, the slide flag 304e is being turned-on, and thus, it is determined that the touch operation is a slide, and in a step S17, it is determined whether or not a locus of the slide is a predetermined locus (a zigzag, in this embodiment). A determining method on whether or not the locus of the slide is a zigzag, that is, the finger is slid to draw a zigzag is described above.

If “NO” is determined in the step S17, that is, if the locus of the slide is not a predetermined locus, it is determined that the slide is not of a deleting operation, and then, the process returns to the step S1 with no action. However, the process may return to the step S1 after a message that a slide operation for deletion is not correctly performed is displayed, or after a warning sound is output. In such a case, instead of the displaying of the message or the outputting of the warning sound, or after the displaying of the message or the outputting of the warning sound, a screen for showing a correct operation method for deletion, i.e. an operation guide screen may be displayed. Furthermore, the displaying may be scrolled according to a slide input in a further manner.

If “YES” is determined in the step S17, that is, if the locus of the slide is the predetermined locus, it is determined that a deleting operation is performed, and in a step S19 shown in FIG. 13, a deletion target is decided based on the locus of the slide. More specifically, the processor 30 decides an operated range E based on the locus of the slide (touch coordinates (points) included in the locus), and a deletion target is decided based on the operated range E. Methods for deciding the operated range E and the deletion target were described above.

In a succeeding step S21, a deletion target is notified. In this step, the processor 30 surrounds the deletion target by the rectangular frame 82 as shown in FIG. 4(B). At this time, the button image 84 for stopping the deletion is displayed on the display 14. In a next step S23, the deletion timer 304f is reset and started.

Subsequently, in a step S25, it is determined whether or not the deletion is to be stopped. In this step, the processor 30 determines whether or not the button image 84 is tapped. If “YES” is determined in the step S25, that is, if the deletion is to be stopped, in a step S27, the deletion target is cancelled, and then, the process returns to the step S1 shown in FIG. 12. Therefore, in a case that an unintentional character or image is decided as a deletion target by failure of the touch operation, for example, by cancelling the deletion target, it is possible to try again to decide a deletion target. That is, it is possible to perform again an operation for deletion.

On the other hand, if “NO” is determined in the step S25, that is, if the deletion is not to be stopped, in a step S29, it is determined whether or not a third predetermined time period (3 seconds, for example) elapses. In this step, the processor 30 determines whether or not a count value of the deletion timer 304f is equal to or larger than the third predetermined time period.

If “NO” is determined in the step S29, that is, if the third predetermined time period does not elapse, the process returns to the step S25 with no action. If “YES” is determined in the step S29, that is, if the third predetermined time period elapses, in a step S31, the deletion target is deleted, and then the process returns to the step S1. At this time, if the deletion target is a character, a character string following the deletion target is moved forward to fill the space.

FIG. 14 is a flowchart of the touch operation determining processing in the step S7 shown in FIG. 12. As shown in FIG. 14, when the touch operation determining processing is started, the processor 30 turns-on the flick flag 304d, and turns-off the tap flag 304c and the slide flag 304e in a step S51. In a next step S53, the flick timer 304g is reset and started.

Subsequently, in a step S55, it is determined whether or not a touch operation exists. In this step, the processor 30 determines whether or not the touch coordinates data are successively stored in an input data buffer 304a. If “YES” is determined in the step S55, that is, if a touch operation exists, it is determined that the touch operation is continued, and in a step S57, it is determined whether or not a count value of the flick timer 304g reaches a first predetermined time period (500 milliseconds, for example).

If “NO” is determined in the step S57, that is, if the count value of the flick timer 304g does not reach the first predetermined time period, the process returns to the step S55 with no action. On the other hand, if “YES” is determined in the step S57, that is, if the count value of the flick timer 304g reaches a first predetermined time period, the flick flag 304d is turned-off in a step S59, and then the process returns to the step S55.

If “NO” is determined in the step S55, that is, if no touch operation exists, it is determined that the touch is released, and in a step S61, a moving distance of the touch operation is calculated. In this step, the processor 30 calculates a distance between the touch coordinates of the start position of the touch operation (the position starting the touch operation) and the touch coordinates of the end position (the position ending (releasing) the touch operation).

In a next step S63, it is determined whether or not the moving distance is a predetermined distance (50 dots, for example) or more. If “NO” is determined in the step S63, that is, if the moving distance is less than the predetermined distance, it is determined that the touch operation is “tap”, and in a step S65, the tap flag 304c is turned-on, and then, the process returns to the whole process.

On the other hand, if “YES” is determined in the step S63, that is, if the moving distance is equal to or longer than the predetermined distance, in a step S67, it is determined whether or not the flick flag 304d is turned-on. If “YES” is determined in the step S67, that is, if the flick flag 304d is turned-on, it is determined that the touch operation is “flick”, and then, the process returns to the whole process with no action. If “NO” is determined in the step S67, that is, if the flick flag 304d is turned-off, it is determined that the touch operation is “slide”, and in a step S69, the slide flag 304e is turned-on, and thereafter, the process returns to the whole process.

According to this embodiment shown, by sliding the finger to draw a predetermined character, symbol or figure such as a zigzag, the deletion target can be decided, and the deletion is performed, and therefore, the displayed object such as a character or image can be easily deleted with an intuitive operation.

A mobile phone 10 according to other embodiments is similar to the above-described embodiment except that in a case that a symbol or the like drawn by two continuous slides is a predetermined symbol or the like, a deletion target is decided and the deletion is performed, and therefore, a duplicated description is omitted here.

In such other embodiments, it is possible to delete a desired displayed object by sliding the finger to draw a doublet, or to draw a cross (x) mark. In addition, in a case that a time period from a first slide being ended to the second slide being started is within a fourth predetermined time period (500 milliseconds-1.0 second, for example), it is determined that the slide is continuously performed twice.

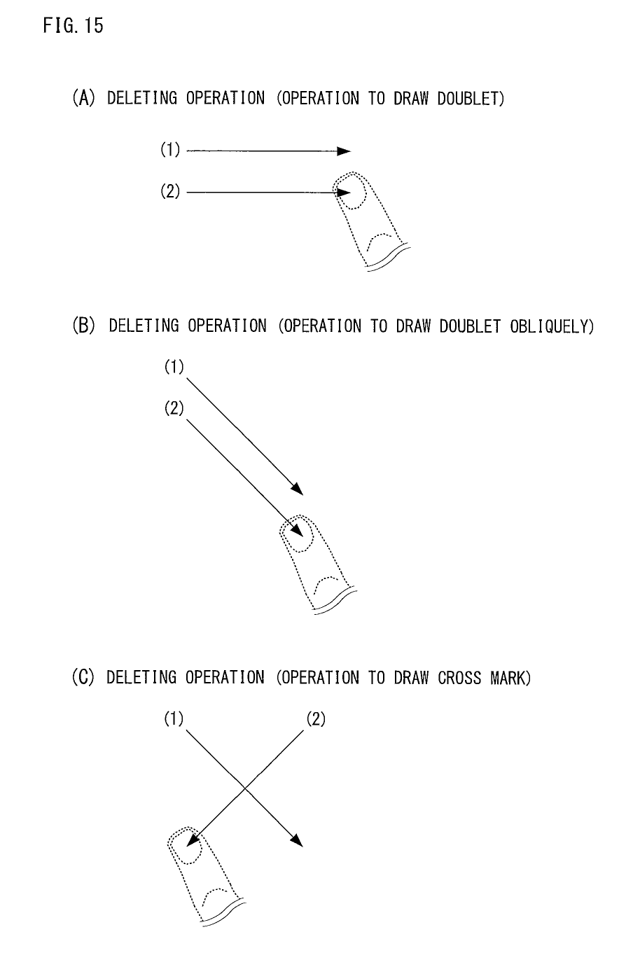

In a case that by performing a slide twice in a horizontal direction to draw a doublet in the horizontal direction as shown in FIG. 15(A), it is possible to determine that a deleting operation is performed. If a Y component of the touch coordinates hardly changes and an X component increases (or decreases), for example, it is determined that a horizontal line is drawn. In other embodiments, the X components of the two horizontal lines are at least partly duplicated, it is determined that the doublet in the horizontal direction is drawn.

Furthermore, in a case that by performing a slide twice in an oblique direction to draw a doublet in the oblique direction as shown in FIG. 15(B), it is also possible to determine a deleting operation is performed. In a case that a Y component decreases (or increases) as an X component of the touch coordinates increases (or decreases), it is determined that a straight line downward to the right is drawn. In such a case, in a case that the X components of the two straight lines are at least partly duplicated, it is determined that a doublet in the oblique direction is drawn.

In addition, although not shown, a doublet that two straight lines downward to the left may be drawn.

Furthermore, in a case that a cross mark is drawn by performing a slide twice in oblique directions different from each other as shown in FIG. 15(C), it is possible to also determine that a deleting operation is performed. In a case that a locus that a Y component decreases as an X component increases and a locus that a Y component decreases as an X component decreases are detected, it is determined that a cross mark is drawn.

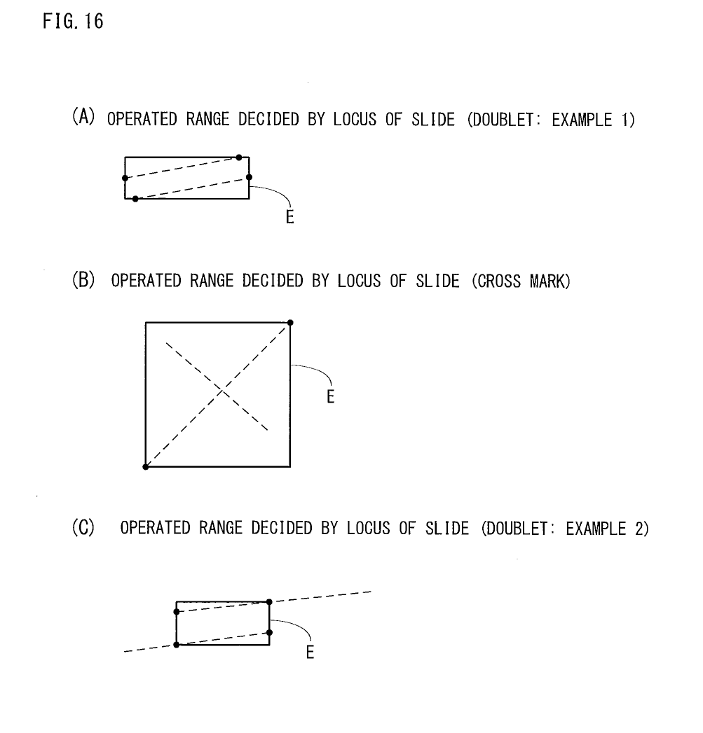

As similar to the above-described embodiments, in a case that a doublet or a cross mark is drawn as shown in FIG. 16(A) and FIG. 16(B), an operated range E can be decided based on a maximum value and a minimum value of the X component of the touch coordinates included in the slide (here, two slides) and a maximum value and a minimum value of the Y component of the touch coordinates. In order to show clearly a deciding method of the operated range E, in FIG. 16(A), the locus of the slide drawing the doublet is shown by slant lines. Such a deciding method is similarly applied to a case that the finger is slid to draw a doublet in an oblique direction. Furthermore, in a case that a doublet is drawn as shown in FIG. 16(C), a portion that two straight lines overlap each other may be decided as an operated range E.

In addition, although not shown, a method for deciding a deletion target based on the operated range E is similar to the method in the above-described embodiment.

Furthermore, if the finger is slid to draw a doublet in the horizontal direction as shown in FIG. 16(A), a displayed object overlapping the touch coordinates constituting the locus can be deleted. However, in a case that the user wishes to delete a character string over three lines or more by sliding the finger to draw a doublet, it is necessary to decide an operated range E based on the touch coordinates constituting the locus of the slide and to decide a deletion target based on the decided operated range E, as described above.

The whole process by the processor 30 according to other embodiments is similar to the whole process described in the above-described embodiment, except for partial changes. In the following, only a different portion will be described. In the whole process of the above-described embodiment, the step S17 is deleted, and between the step S15 and the step S19, the steps S81, S83, S85, S87, S89 and S91 are added. Furthermore, in the touch operation determining processing of the step S7, the kind of the first operation (first time operation) is determined.

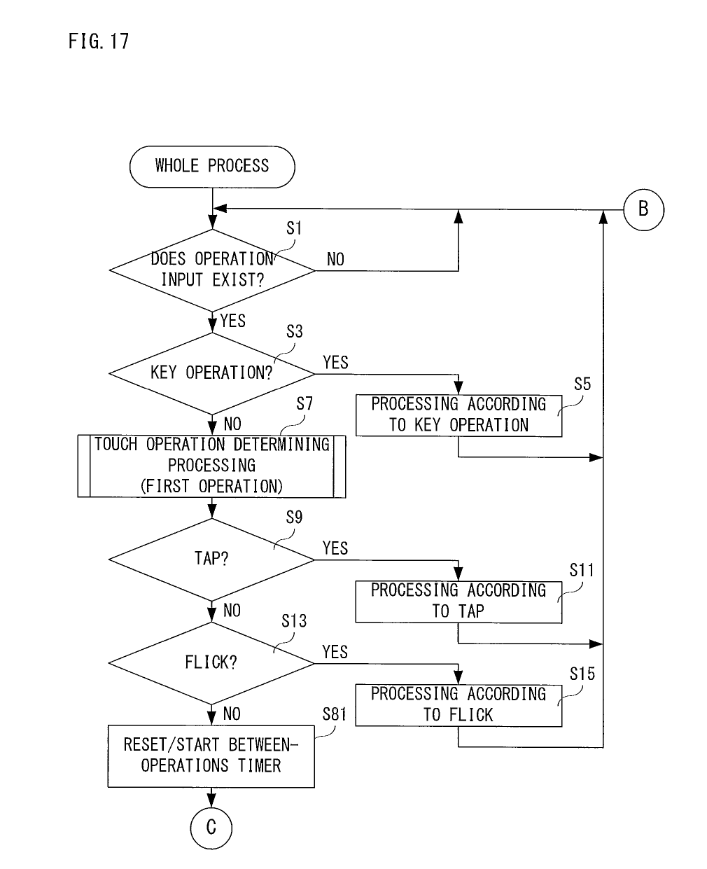

As shown in FIG. 17, if “NO” is determined in the step S13, that is, if the touch operation is not a flick, it is determined that the touch operation is a slide, and in a step S81, a between-operations timer is reset and started. The between-operations timer is a timer provided in the data storage area 304 in other embodiment to count a fourth predetermined time period between a first operation (a first time slide) and a second operation (a second time slide).

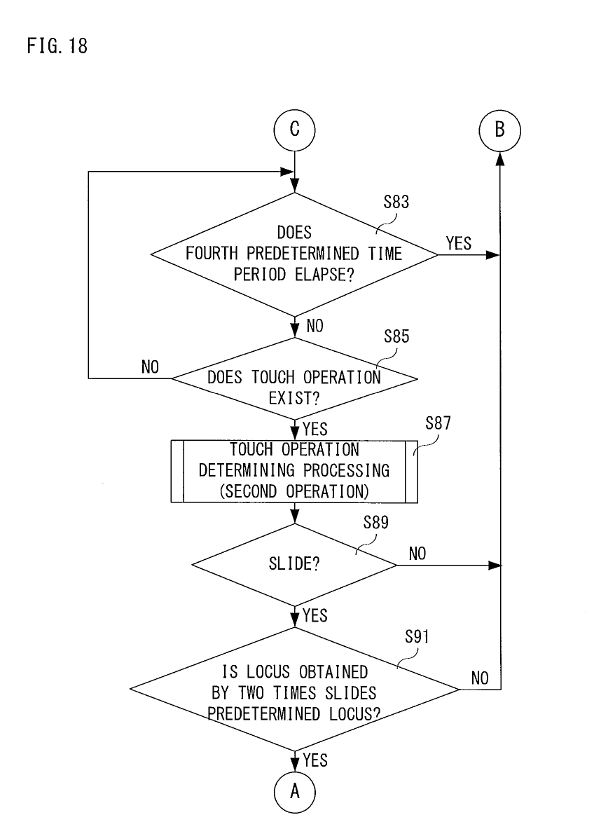

As shown in FIG. 18, in a subsequent step S83, it is determined whether or not a count value of the between-operation timer reaches a fourth predetermined time period (500 milliseconds, for example). If “YES” is determined in the step S83, that is, if the count value of the between-operation timer is equal to or larger than the fourth predetermined time period, it is determined that the touch operation is only a single slide, and then, the process returns to the step S1 shown in FIG. 17.

If “NO” is determined in the step S83, that is, if the count value of the between-operation timer does not reaches the fourth predetermined time period, in a step S85, it is determined whether or not a touch operation exists. That is, it is determined whether or not the touch coordinates data at a current time is stored in the input data buffer 304a. If “NO” is determined in the step S85, that is, if no touch operation exists, the process returns to the step S83 with no action. If “YES” is determined in the step S85, that is, if a touch operation exists, in a step S87, the touch operation determining processing for the second operation (second time operation) is performed. The touch operation determining processing in the step S87 is the same as the touch operation determining processing in FIG. 14, but performed based on the touch coordinates detected as the second operation.

Subsequently, in a step S89, it is determined whether or not the touch operation is a slide. In this step, the processor 30 determines whether or not the slide flag 304e is turned-on. If “NO” is determined in the step S89, that is, if the touch operation is not a slide, it is determined that the touch operation is not of a deleting operation, then the process returns to the step S1. On the other hand, if “YES” is determined in the step S89, that is, if the touch operation is a slide, in a step S91, it is determined whether or not a locus of the two times slides is a predetermined locus. Such a determining method is as just described above.

If “NO” is determined in the step S91, that is, if the two times slides is not the predetermined locus, it is determined that the two times slides is not of a deleting operation, and the process returns to the step S1. If “YES” is determined in the step S91, that is, if the locus of the two times slides is the predetermined locus, it is determined that the two times slides is of a deleting operation, and then, processing in the step S19 shown in FIG. 13 and thereafter is performed.

In other embodiments, only by sliding the finger to draw a predetermined symbol or the like such as a doublet or a cross mark, since it is possible to designate a deletion target and thus to perform deletion, the displayed object can be easily deleted with an intuitive operation.

In addition, in the above-described embodiments, by one time slide or two times slides, the deletion target is decided and the deletion is performed, but not limited thereto. For example, it is possible to decide a deletion target and perform the deletion by three times slides. The deletion target is decided by the first and second slides, and in response to the third slide, the deletion is performed.

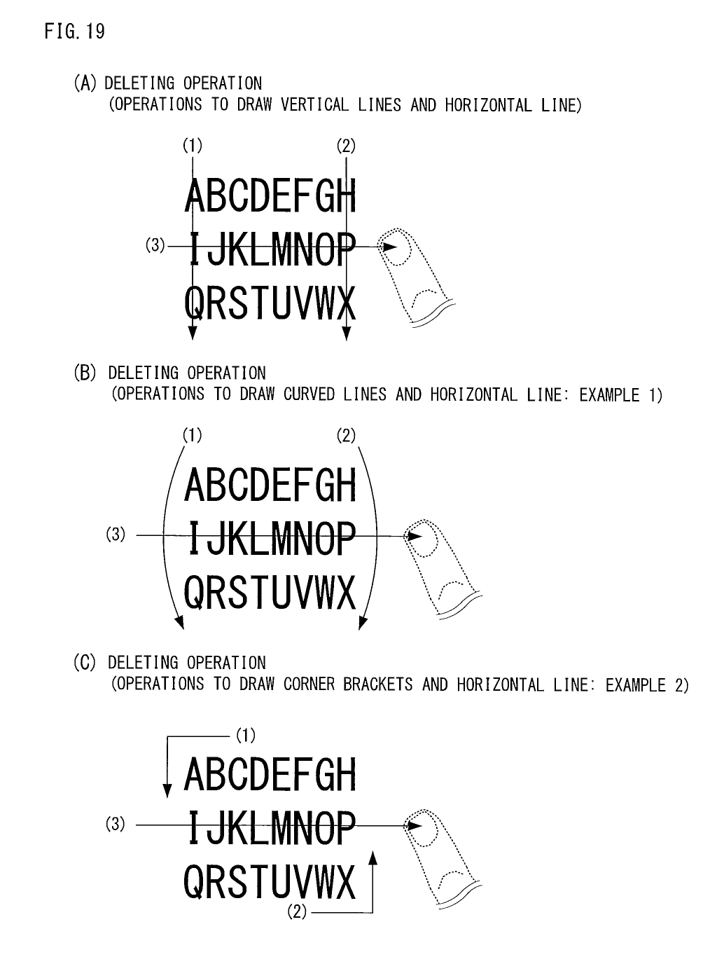

More specifically, as shown in FIG. 19(A), the finger is slid to draw a first vertical line on characters to be deleted positioned at a left end, and then, the finger is slid to draw a second vertical line on characters to be deleted positioned at a right end. Based on the two vertical lines, an operated range E is decided, and then, a deletion target is decided based on the operated range E, and thereafter, by sliding the finger to draw a horizontal line intersecting (orthogonally intersecting) to the two vertical lines, the deletion is performed. In addition, after the deletion target is decided, even if the finger is not slid to draw the horizontal line, at a time that the third predetermined time period elapses, the deletion may be performed. This is true for cases shown in FIG. 19(B) and FIG. 19(C).

As shown in FIG. 19(B), instead of the vertical lines, the finger is slid to draw two curved lines so as to sandwich characters to be deleted, and the operated range is decided based on the two curved lines, and further, by sliding the finger to draw a horizontal line intersecting two curved lines, the deletion is performed.

As shown in FIG. 19(C), by sliding the finger to draw corner brackets, and an operated range is decided based on the corner brackets, and by sliding the finger to draw a horizontal line passing between the corner brackets, the deletion is performed.

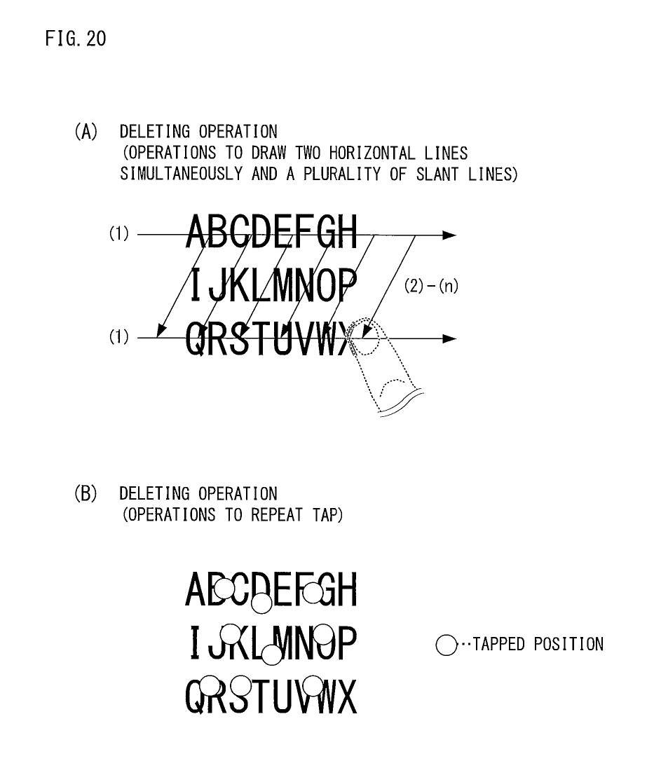

In a further embodiment, it is possible to decide a deletion target and perform the deletion by four or more times slides or continuous tap. For example, as shown in FIG. 20(A), upper and lower ranges of the operated range E are simultaneously designated by two fingers, and by sliding the finger to draw a plurality of slant lines between the two lines simultaneously drawn, left and right ranges of the operated range E are decided, and further, a deletion target is decided based on the operated range E. In such a case, an operated range E is decided based on a maximum value and a minimum value of a Y component of the touch coordinates included in the two lines drawn by two fingers and a maximum value and a minimum value of an X component of the touch coordinates included in the plurality of slant lines drawn between the two lines.

As shown in FIG. 20(B), by continuously tapping characters to be deleted, an operated range E is decided. In such a case, the operated range E is decided based on a maximum value and a minimum value of an X component of the touch coordinates of the touch positions tapped and a maximum value and a minimum value of a Y component of the touch coordinates of the touch positions tapped. For example, a continuous number of times of the tap by which it is determined that the tapping operation is for a deleting operation is five or more. If the fifth predetermined time period (500 milliseconds-1.0 second, for example) elapses from the last tap, it is possible to determine that the tap is terminated.

Furthermore, in the above-described embodiments, if the deletion is stopped until the third predetermined time period elapses after the deletion target is decided, the deletion target is cancelled not to perform the deletion, but not limited thereto. For example, if the deletion target is decided, the deletion target is immediately deleted, and a predetermined operation exist until a sixth predetermined time period (3 seconds, for example) elapses after the deletion target is deleted, the deletion target may be undone. The predetermined operation for undoing the deletion target may be the same as that of a case that the deletion is stopped. That is, after the deletion target is deleted, a predetermined button image is displayed on the screen, and if the button image is turned-on (tapped) until the sixth predetermined time period elapses, the deletion target is undone. Furthermore, after the deletion target is deleted, the deletion target may be undone by depressing a predetermined hardware key or by drawing a predetermined character or the like.

In addition, in the above-described case, instead of the deletion timer of the above-described embodiments, a timer (here, called as “an undoing timer”) for counting the sixth predetermined time period for determining whether or not the deletion target is to be undone is provided.

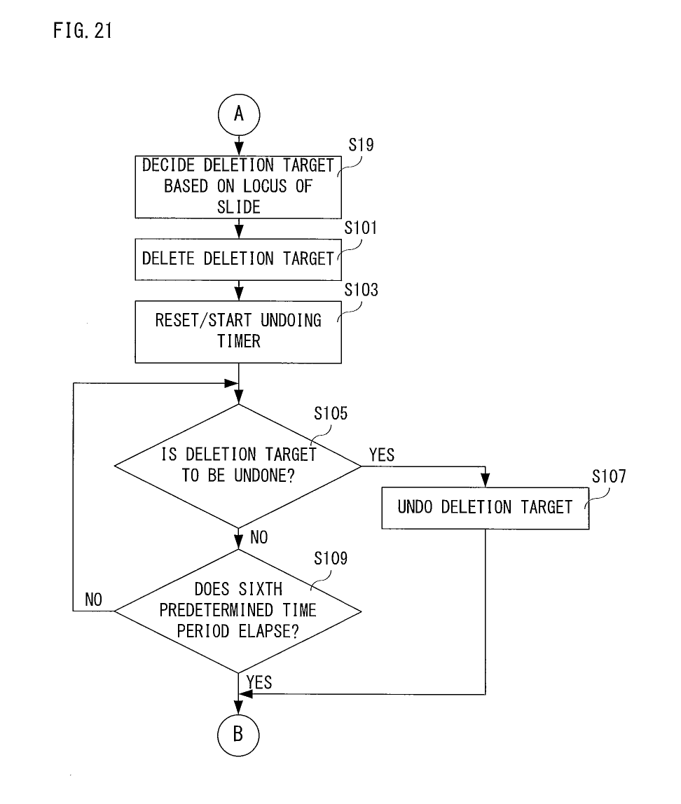

Specifically, since the whole process according to the further embodiment is the same as the whole process shown in FIG. 12 and FIG. 13 except a part being different as shown in FIG. 21, only a different portion will be described. As shown in FIG. 21, if the deletion target is decided in the step S19, in a step S101, the deletion target is deleted. That is, the deletion target is erased from the screen. In addition, in FIG. 21, when the deletion target is decided, immediately the deletion target is deleted, but the deletion target may be deleted after the deletion target is notified.

In a step S103, the undoing timer is reset and started. Then, in a step S105, it is determined whether or not the deletion target is to be undone. If “YES” is determined in the step S105, that is, if the deletion target is to be undone, in a step S107, the deletion target is undone, and then, the process returns to the step S1. That is, the deletion target erased from the screen in the step S101 becomes to be displayed at its original position. If “NO” is determined in the step S105, that is, if the deletion target is not to be undone, in a step S109, it is determined whether or not a count value of the undoing timer reaches a sixth predetermined time period.

If “NO” is determined in the step S109, that is, if the count value of the undoing timer does not reach the sixth predetermined time period, the process returns to the step S105. On the other hand, if “YES” is determined in the step S109, that is, if the count value of the undoing timer reaches the sixth predetermined time period, the process returns to the step S1.

Programs utilized in the above-described embodiments may be stored in an HDD of the server for data distribution, and distributed to the mobile phone 10 via the network. The plurality of programs may be stored in a storage medium such as an optical disk of CD, DVD, BD (Blu-ray Disc) or the like, a USB memory, a memory card, etc. and then, such the storage medium may be sold or distributed. In a case that the plurality of programs downloaded via the above-described server or storage medium are installed to a mobile terminal having the structure equal to the structure of the embodiment, it is possible to obtain advantages equal to advantages according to the embodiment.

The specific numerical values mentioned in this specification are only examples, and changeable properly in accordance with the change of product specifications.

An embodiment is electronic equipment with a display portion which displays an object including at least a character, comprising: an operation detecting portion which detects a touch operation to a touch panel provided on a surface of the display portion; a determining portion which determines whether a touch operation detected by the operation detecting portion is an operation to draw a predetermined locus; and a deleting portion which deletes, when it is determined by the determining portion that the touch operation is an operation to draw the predetermined locus, a part or all of the object being displayed on the display portion and having a predetermined relationship with respect to points included in the locus of the touch operation.

In the embodiment the electronic equipment (10) is provided with the display portion (14) which displays an object including at least a character. The object is a symbol including a character or an image, for example, and there is a case that these are displayed together. The operation detecting portion (30, S1) detects a touch operation to a touch panel (16) provided on a surface of the display portion. The determining portion (30, S17) determines whether the touch operation detected by the detecting portion is an operation to draw a predetermined locus. It is determined whether or not a locus by the touch operation represents the predetermined locus, for example. Furthermore, it is determined whether a predetermined number of points or more are continuously designated by the touch operation, for example. The deleting portion (30, S31) deletes, when it is determined by the determining portion that the touch operation is an operation to draw the predetermined locus, a part or all of the object being displayed on the display portion and having a predetermined relationship with respect to points included in the locus of the touch operation. For example, a part or all of the object is designated by the points included in the locus of the touch operation is deleted.

According to the embodiment, if and when the locus by the touch operation represents a predetermined locus, a part or all of an object being displayed on the display portion is deleted based on the points included in the touch operation, and thus, it is possible to easily delete the object through an intuitive operation.

Another embodiment is the electronic equipment wherein the deleting portion deletes, when a first predetermined time period elapses from a timing that a part or all of the object to be deleted is decided as a deletion target, the deletion target.

In this embodiment, if a part or all of the object to be deleted is decided as a deletion target, displays the deletion target in a manner capable of identifying the deletion target. Then, when a first predetermined time period elapses the deleting portion deletes the deletion target.

According to this embodiment, since the deletion target is automatically deleted when the first predetermined time period elapses, it is possible to save time and effort by a user.

A further embodiment is the electronic equipment further comprising a canceling portion which cancels the deletion target when a first predetermined input exists before the first predetermined time period elapses from a timing that a part or all of the object is decided as the deletion target.

In the further embodiment, the canceling portion (30, S27) cancels the deletion target when a first predetermined input exists before the first predetermined time period elapses from a timing that a part or all of the object is decided as the deletion target. The first predetermined input includes a tapping to a button image displayed on the display portion, a drawing of a predetermined symbol or figure with using the touch panel, and an operation to a predetermined hardware key.

According to the further embodiment, since the deletion target can be canceled, even if the user fails to perform a touch operation representing the predetermined locus, it is possible to try again such an operation for deleting.

A still further embodiment is the electronic equipment further comprising an undoing portion which undoes a part or all of the object having been deleted when a second predetermined input exists before a second predetermined time period elapses from a timing that a part or all of the object is deleted by the deleting portion.

In the still further embodiment, the undoing portion (30, S107) undoes the part of or entire the object having been deleted when a second predetermined input exists before a second predetermined time period elapses from a timing that a part or all of the object is deleted by the deleting portion. That is, a part or all of the object having been deleted once can be restored.

According to the still further embodiment, since a part or all of the object having been deleted once is restored, even if the user fails to perform a touch operation for deleting, it is possible to undo the object. Therefore, it is possible to try again such an operation for deleting.

Another embodiment is the electronic equipment wherein the predetermined relationship includes a condition that a part or all of the points included in the touch operation indicating the predetermined locus and a part or all of the object are overlapped.

In this embodiment, when that a part or all of the points included in the touch operation indicating the predetermined locus and the part of or entire the object are overlapped, a part or all of the object is deleted.

According to this embodiment, by performing a touch operation to draw the predetermined locus on the object to be deleted, it is possible to delete a portion that the touch operation and the object are overlapped. Accordingly, it is possible to easily delete the object by an intuitive operation.

A further another embodiment is the electronic equipment wherein the predetermined relationship includes a condition that a part or all of the points included in the touch operation indicating the predetermined locus surrounds a part or all of the object.

In this embodiment, when a part or all of the points included in the touch operation representing the predetermined locus surrounds a part or all of the object, a part or all of the object is deleted.

According to this embodiment, by performing a touch operation to draw the predetermined locus on the object to be deleted, it is possible to delete a portion where the touch operation surrounds the object. Accordingly, it is possible to easily delete the object by an intuitive operation.

A still further another embodiment is a non-transitory storage medium storing a deleting program for electronic equipment with a display portion which displays an object including at least a character, wherein the deleting program causes a processor of the electronic equipment to: detect a touch operation to a touch panel provided on a surface of the display portion; determine whether a touch operation detected is an operation to draw a predetermined locus; and delete, when it is determined that the touch operation is an operation to draw the predetermined locus, a part or all of the object being displayed on the display portion and having a predetermined relationship with respect to points included in the locus of the touch operation.

According to this embodiment, as similar to the above-described embodiment, it is also possible to easily delete the object through an intuitive operation.

The other embodiment is a deletion controlling method of electronic equipment with a display portion which displays an object including at least a character, a processor of the electronic equipment performing steps of: (a) detecting a touch operation to a touch panel provided on a surface of the display portion; (b) determining whether a touch operation detected in the step (a) is an operation to draw a predetermined locus; and (c) deleting, when it is determined that the touch operation is an operation to draw the predetermined locus in the step (b), a part or all of the object being displayed on the display portion and having a predetermined relationship with respect to points included in the locus of the touch operation.

According to the other embodiment, as similar to the above-described embodiment, it is also possible to easily delete the object through an intuitive operation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. Electronic equipment with a display portion which displays an object including at least a character, comprising:
an operation detecting portion which detects a touch operation to a touch panel provided on a surface of the display portion;
a determining portion which determines whether a touch operation detected by the operation detecting portion is an operation to draw a predetermined locus; and
a deleting portion which deletes, when it is determined by the determining portion that the touch operation is an operation to draw the predetermined locus, a part or all of the object being displayed on the display portion and having a predetermined relationship with respect to points included in the locus of the touch operation.

2. The electronic equipment according to claim 1, wherein the deleting portion deletes, when a first predetermined time period elapses from a timing that a part or all of the object to be deleted is decided as a deletion target, the deletion target.

3. The electronic equipment according to claim 2, further comprising a canceling portion which cancels the deletion target when a first predetermined input exists before the first predetermined time period elapses from a timing that a part or all of the object is decided as the deletion target.

4. The electronic equipment according to claim 1, further comprising an undoing portion which undoes a part or all of the object having been deleted when a second predetermined input exists before a second predetermined time period elapses from a timing that a part or all of the object is deleted by the deleting portion.

5. The electronic equipment according to claim 1, wherein the predetermined relationship includes a condition that a part or all of the points included in the touch operation indicating the predetermined locus and a part or all of the object are overlapped.

6. The electronic equipment according to claim 1, wherein the predetermined relationship includes a condition that a part or all of the points included in the touch operation indicating the predetermined locus surrounds a part or all of the object.

7. A non-transitory storage medium storing a deleting program for electronic equipment with a display portion which displays an object including at least a character, wherein the deleting program causes a processor of the electronic equipment to:
detect a touch operation to a touch panel provided on a surface of the display portion;
determine whether a touch operation detected is an operation to draw a predetermined locus; and
delete, when it is determined that the touch operation is an operation to draw the predetermined locus, a part or all of the object being displayed on the display portion and having a predetermined relationship with respect to points included in the locus of the touch operation.

8. A deletion controlling method of electronic equipment with a display portion which displays an object including at least a character, a processor of the electronic equipment performing steps of:
(a) detecting a touch operation to a touch panel provided on a surface of the display portion;
(b) determining whether a touch operation detected in the step (a) is an operation to draw a predetermined locus; and
(c) deleting, when it is determined that the touch operation is an operation to draw the predetermined locus in the step (b), a part or all of the object being displayed on the display portion and having a predetermined relationship with respect to points included in the locus of the touch operation.
